(19) United States
(12) Patent Application Publication
(10) Pub. No.: US 2024/0116459 A1
(43) Pub. Date: Apr. 11, 2024

(54) MOUNTING SYSTEM AND KIT FOR MOUNTING AN ACCESSORY ON A VEHICLE

(71) Applicant: SOUCY INTERNATIONAL INC., Drummondville (CA)

(72) Inventors: Philippe JAILLET-GOSSELIN, Drummondville (QC); Frederik BESSETTE, Beloeil (CA); Jean-Michel LECLERC, Drummondville (CA); Michel PELLERIN, Drummondville (CA); Martin PROVENCHER, Saint-Edmond-de-Grantham (CA); Alexandra BANVILLE, Drummondville (CA)

(21) Appl. No.: 18/377,506

(22) Filed: Oct. 6, 2023

Related U.S. Application Data
(60) Provisional application No. 63/413,685, filed on Oct. 6, 2022.

(51) Int. Cl. B60R 11/06

(52) U.S. Cl. CPC B60R 11/06; B60R 2011/0071

(57) ABSTRACT

A mounting system and a kit for installing an accessory on a vehicle are disclosed. The mounting system has a base including a foot portion and a first interface portion. The base defines an axis extending through the first interface portion. The mounting system has an interchangeable swivel member including a second interface portion and an accessory portion. The first interface portion and the second interface portion being configured to selectively engage each other in a first configuration and a second configuration. The mounting system has a resilient connection assembly configured to resiliently connect the interchangeable swivel member to the base. The resilient connection assembly includes a biasing element configured to exert a biasing force to axially bias the first interface portion towards the second interface portion.

### CROSS-REFERENCE TO RELATED APPLICATION

The present application claims priority to U.S. Provisional Patent Application No. 63/413,685, filed Oct. 6, 2022, the entirety of which is incorporated by reference herein.

### TECHNICAL FIELD

The present technology relates to mounting systems and kits for installing accessories on a vehicle.

### BACKGROUND

Many owners of road and off-road vehicles use their vehicles for transportation of various items and accessories, such as snowmobiles, bicycles, jerry cans and tools such as shovels, axes, lights, and like. In many cases, these items and accessories are secured to the vehicle using tie downs and bungee cords.

However, users may have difficulties securing items using these conventional methods. Tie downs or bungee cords can be awkward and difficult for certain items and accessories. They may also not provide a secure grip, especially on rough terrain, and items and accessories may slip off or slide around the vehicle. Therefore, there is a need for a system to easily and securely fasten accessories and items to vehicles.

### SUMMARY

It is an object of the present technology to ameliorate at least some of the inconveniences present in the prior art.

In a first broad aspect of the present technology, there is provided a mounting system for installing an accessory on a vehicle. The mounting system comprises a base including a foot portion and a first interface portion. The foot portion is configured to be selectively connected to the vehicle. The first interface portion extends from the foot portion. The base defines an axis extending through the first interface portion. The mounting system comprises an interchangeable swivel member including a second interface portion and an accessory portion. The first interface portion and the second interface portion are configured to selectively engage each other in a first configuration and a second configuration. When the first interface portion and the second interface portion are disengaged, the interchangeable swivel member is rotatable relative to the base about the axis from a first position to a second position. When the first interface portion and the second interface portion are engaged, the interchangeable swivel member is prevented from rotating relative to the base about the axis. The mounting system comprises a resilient connection assembly configured to resiliently connect the interchangeable swivel member to the base. The resilient connection assembly includes a biasing element configured to exert a biasing force to axially bias the first interface portion towards the second interface portion such that: (i) when the interchangeable swivel member is axially pulled by an operator away from the base, the first interface portion disengages the second interface portion, (ii) when the interchangeable swivel member is in the first position and is released by the operator, the first interface portion engages the second interface portion in the first configuration, and (iii) when the interchangeable swivel member is in the second position and is released by the operator, the first interface portion engages the second interface portion in the second configuration.

In some embodiments of the mounting system, one of the first and second interface portions defines a lip and a shoulder, and when the first interface portion engages the second interface portion: the other one of the first and second interface portions is biased against the shoulder and receives the lip, thereby preventing rotation of the first interface portion relative to the second interface portion about the axis.

In some embodiments of the mounting system, the lip and the shoulder are defined along a perimeter of the one of the first and second interface portions.

In some embodiments of the mounting system, the first interface portion defines a first aperture, the first aperture for receiving at least a portion of the resilient connection assembly, the axis extending through the first aperture.

In some embodiments of the mounting system, the resilient connection assembly further includes a biasing adjustment means for manually adjusting the biasing force of the biasing element.

In some embodiments of the mounting system, the resilient connection assembly further includes a fastener configured to apply the biasing force to the interchangeable swivel member.

In some embodiments of the mounting system, the foot portion defines a foot aperture configured to cooperate with an anchoring system for selectively attaching the base to the vehicle.

In some embodiments, the vehicle has an interface configured to have the anchoring system anchored thereto.

In some embodiments, the anchoring system is adjustable between first and second configurations. With the anchoring system being in the first configuration, the anchoring system is selectively connectable to the vehicle. With the anchoring system being in the second configuration, the anchoring system is fixed to the vehicle

In some embodiments of the mounting system, the base further includes an intermediate portion extending away from the foot portion and towards the first interface portion.

In some embodiments of the mounting system, the intermediate portion has a second aperture for receiving a strap.

In some embodiments of the mounting system, the accessory portion is the accessory.

In some embodiments of the mounting system, the accessory portion is configured to selectively connect the accessory to the interchangeable swivel member.

In some embodiments of the mounting system, the interchangeable swivel member has a handle.

In some embodiments of the mounting system, the accessory is at least one of a shovel, an axe, a frame member, a retention member, and a light.

In a second broad aspect of the present technology, there is provided a kit for installing an accessory on a vehicle. The kit comprises a base including a foot portion and a first interface portion. The foot portion is selectably connectable to the vehicle. The first interface portion extends from the foot portion. The base defines an axis extending through the first interface portion. The kit comprises an interchangeable swivel member including a second interface portion and an accessory portion. The first interface portion and the second interface portion are configured to selectively engage each other in a first configuration and a second configuration. When the first interface portion and the second interface portion are disengaged, the interchangeable swivel member is rotatable relative to the base about the axis from a first position to a second position. When the first interface portion and the second interface portion are engaged, the interchangeable swivel member is prevented from rotating relative to the base about the axis. The kit comprises a resilient connection assembly configured to resiliently connect the interchangeable swivel member to the base. The resilient connection assembly includes a biasing element configured to exert a biasing force to axially bias the first interface portion towards the second interface portion such that: (i) when the interchangeable swivel member is axially pulled by an operator away from the base, the first interface portion disengages the second interface portion, (ii) when the interchangeable swivel member is in the first position and is released by the operator, the first interface portion engages the second interface portion in the first configuration, and (iii) when the interchangeable swivel member is in the second position and is released by the operator, the first interface portion engages the second interface portion in the second configuration.

In some embodiments of the kit, the kit further comprises an other interchangeable swivel member including an other second interface portion and an other accessory portion. The other accessory portion is different from the accessory portion.

In some embodiments of the kit, the accessory portion is the accessory.

In some embodiments of the kit, the kit further comprises the accessory.

In some embodiments, the kit further includes an anchoring system to selectively connect the foot portion of the base to the vehicle.

In some embodiments, the vehicle has an interface configured to have the anchoring system anchored thereto.

In some embodiments, the anchoring system is adjustable between a first configuration and a second configuration. With the anchoring system being in the first configuration, the anchoring system is selectively connectable to the vehicle. With the anchoring system being in the second configuration, the anchoring system being fixed to the vehicle.

According to another aspect of the present technology, there is provided a mounting system for mounting an accessory on a vehicle. The mounting system includes a base. A stopping assembly, and an interchangeable swivel member. The base includes a foot portion configured to be selectively connectable to the vehicle, and a first interface portion extending from the foot portion, and having a retainer. The stopping assembly includes a stopping member moveable between a stopping position and a releasing position, and a biasing member operatively connected to the stopping member for biasing the stopping member toward the stopping position. The interchangeable swivel member includes a second interface portion selectively connected to the first interface portion in at least two configurations, and an accessory portion. With the first interface portion being connected to the second interface portion, and in response to the stopping member being in the stopping position, the stopping member stops the interchangeable swivel member from moving relative to the base in a first direction, and the retainer stops the interchangeable swivel member from moving relative to the base in a second direction and a third direction, the second direction being different from the first direction, and the third direction being different from the first and second directions. With the first interface portion being connected to the second interface portion, and in response to the stopping member being in the releasing position, the interchangeable swivel member is free to move relative to the base in the first direction, and in response to the interchangeable swivel member being moved relative to the base in the first direction, the interchangeable swivel member being free to move relative to the base in at least the third direction.

In some embodiments, the base defines a base axis extending through the first interface portion, the first direction extends along a first axis orthogonal to the base axis, the second direction extends along a second axis orthogonal to the base and first axes, and the third direction extends along a third axis parallel to the base axis.

In some embodiments, the stopping member has a stopping portion configured to abut part of the second interface portion when the stopping member is in the stopping position, and the second interface portion defines a passage for receiving the stopping portion when the stopping member is in the releasing position.

In some embodiments, the second interface portion defines an opening connected to the passage, the opening being configured to receive the retainer therethrough.

In some embodiments, the passage and the opening form a T-shape.

In some embodiments, the passage is a first passage, and the mounting system further defines a second passage, a third passage and a fourth passage, the first, second, third and fourth passages intersecting to define a cross-like shape.

In some embodiments, the retainer defines a gap between an upper surface of the base and a lower surface of the retainer, the gap being configured to receive part of the second interface portion therein.

In some embodiments, the accessory portion includes at least one of: a belt, a shovel, an axe, a frame member, a retention member, and a light.

In some embodiments, the biasing member is a spring.

In some embodiments, the foot portion defines a foot aperture configured to cooperate with an anchoring system for selectively attaching the base to the vehicle.

In some embodiments, the vehicle has an interface configured to have the anchoring system anchored thereto.

In some embodiments, the anchoring system is adjustable between a first configuration and a second configuration. With the anchoring system in the first configuration, the anchoring system is selectively connectable to the vehicle. With the anchoring system in the second position, the anchoring system is fixed to the vehicle.

According to another aspect of the present technology, there is provided a kit for mounting an accessory on a vehicle. The kit includes a base, a stopping assembly, and an interchangeable swivel member. The base includes a foot portion configured to be selectively connectable to the vehicle, and a first interface portion extending from the foot portion, and having a retainer. The stopping assembly includes a stopping member moveable between a stopping position and a releasing position, and a biasing member operatively connected to the stopping member for biasing the stopping member toward the stopping position. The interchangeable swivel member includes a second interface portion selectively connected to the first interface portion in at least two configurations, and an accessory portion. With the first interface portion being connected to the second interface portion, and in response to the stopping member being in the stopping position, the stopping member stops the interchangeable swivel member from moving relative to the base in a first direction, and the retainer stops the interchangeable swivel member from moving relative to the base in a second direction and a third direction, the second direction being different from the first direction, and the third direction being different from the first and second directions. With the first interface portion being connected to the second interface portion, and in response to the stopping member being in the releasing position, the interchangeable swivel member is free to move relative to the base in the first direction, and in response to the interchangeable swivel member being moved relative to the base in the first direction, the interchangeable swivel member being free to move relative to the base in at least the third direction.

In some embodiments, the kit further comprises an other interchangeable swivel member including an other second interface portion and an other accessory portion, the other accessory portion being different from the accessory portion.

In some embodiments, the accessory portion is the accessory.

In some embodiments, the kit further comprises the accessory.

In some embodiments, the kit further includes an anchoring system to selectively connect the foot portion of the base to the vehicle.

In some embodiments, the vehicle has an interface configured to have the anchoring system anchored thereto.

In some embodiments, the anchoring system is adjustable between a first configuration and a second configuration, and with the anchoring system being in the first configuration, the anchoring system being selectively connectable to the vehicle, with the anchoring system being in the second position, the anchoring system being fixed to the vehicle.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a mounting system in accordance with some embodiments of the present technology;

FIG. 2 is a perspective view of a base of the mounting system of FIG. 1;

FIG. 3 is a perspective view of a swivel member of the mounting system of FIG. 1;

FIG. 4 is an exploded view of a resilient of the mounting system of FIG. 1;

FIG. 5 is an exploded view of the mounting system of FIG. 1;

FIG. 6 is a cross-sectional view of the mounting system of FIG. 1 passing through a line 6-6 of FIG. 1;

FIG. 7A depicts a pair of mounting systems connecting a shovel to an ATV in accordance with some embodiments of the present technology;

FIG. 7B depicts a pair of mounting systems that connects a rake to truck in accordance with some embodiments of the present technology;

FIG. 8A depicts a mounting system comprising an other base and an other swivel member in accordance with an other embodiment of the present technology;

FIG. 8B depicts a mounting system comprising an additional base and an additional swivel member in accordance with an additional embodiment of the present technology;

FIGS. 9A-9C depict a swivel member selectively engaging a base of a mounting system in a first configuration, a second configured and a third configuration 920, respectively, in accordance with some embodiments of the present technology;

FIGS. 10A-10D depict a series of schematic illustrations of operation of a mounting system for selectively engaging a base with a swivel member in a second configuration when the base and the swivel member are in a first configuration, in accordance with some embodiments of the present technology

FIG. 11 is a perspective view of an alternative embodiment of the mounting system of FIG. 1;

FIG. 12 is a perspective view of a base of the mounting system of FIG. 11, with a swivel member being omitted;

FIG. 13 is a perspective view of the swivel member of the mounting system of FIG. 11, with the base being omitted;

FIG. 14 is a perspective view of the base and the swivel member, with an accessory portion of the swivel member being omitted;

FIG. 15 is a top plan view of the base and the swivel member of FIG. 14, with a stopping member being in a stopping position;

FIG. 16 is a cross-sectional view of the base and the swivel member of FIG. 14 passing through a line 16-16 of FIG. 15;

FIG. 17 is a top plan view of the base and the swivel member of FIG. 14, with the stopping member being in a releasing position; and

FIG. 18 is a cross-sectional view of the base and the swivel member of FIG. 17 passing through a line 18-18 of FIG. 17.

### DESCRIPTION OF EMBODIMENTS

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the following description, “outwardly” or “outward” means away from a longitudinal center plane of the mounting clamp, and “inwardly” or “inward” means toward the longitudinal center plane. In addition, in the context of the following description, “longitudinally” means in a direction parallel to the longitudinal center plane of the mounting clamp in a plane parallel to flat level ground, “laterally” means in a direction perpendicular to the longitudinal center plane along a width of the mounting clamp, and “generally vertically” means in a direction contained in the longitudinal center plane along a height direction of the mounting clamp. Note that in the Figures, a “+” symbol is used to indicate an axis of rotation. In the context of the present technology, the term “axis” may be used to indicate an axis of rotation. Also, the term “pivot” includes all the necessary structure (bearing structures, pins, axles and other components) to permit a structure to pivot/rotate about an axis, as the case may be.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

### Mounting System

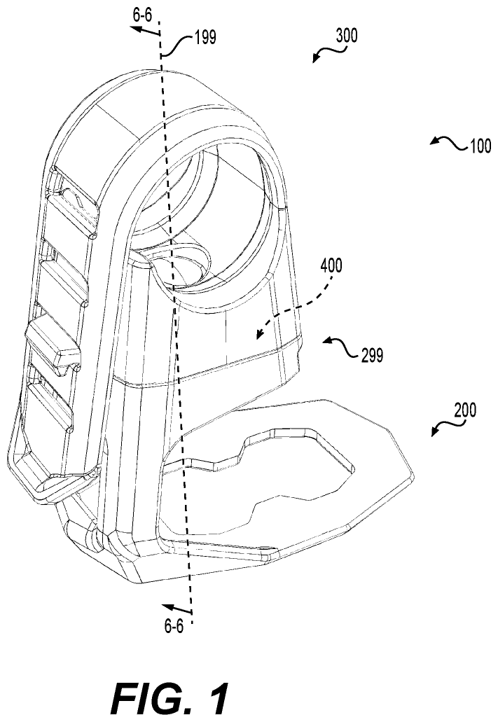

With reference to FIG. 1, there is depicted a non-limiting embodiment of a mounting system 100. In this embodiment, the mounting system 100 comprises a base 200 and a swivel member 300. The base 200 defines an axis 199 that extends through the swivel member 300. The mounting system 100 also comprises an interface 299. The interface 299 is configured to selectively engage the base 200 with the swivel member 300. A first portion of the interface 299 may be defined by the base 200 and a second portion of the interface 299 may be defined by the swivel member 300. The mounting system 100 also comprises a resilient connection assembly 400. The resilient connection assembly 400 is configured to resiliently connect the base 200 with the swivel member 300 by axially biasing the base 200 against the swivel member, and/or vice versa, along the axis 199.

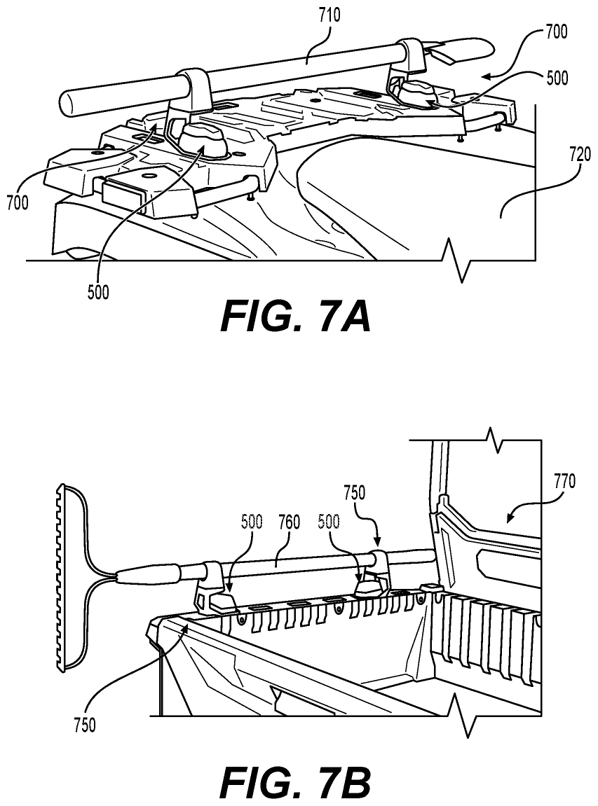

With a quick reference to FIG. 7A there is depicted a pair of mounting systems 700 that connects a shovel 710 to an ATV 720. With a quick reference to FIG. 7B there is depicted a pair of mounting systems 750 that connects a rake 760 to truck 770. The mounting systems 700 and 750 can be implemented in a similar manner to the mounting system 100.

It should be noted that the mounting system 100 may also be configured to install a variety of tools to a variety of vehicles. For example, the base 200 may be selectively attached to a vehicle interface. The vehicle interface may be a structural component of a vehicle. In one embodiment, the support member may be a structural component of a powersport vehicle (e.g., a snowmobile, a quad, an ATV, a Side-by-Side, a UTV, a cross-country motorcycle, and the like) configured to support one or more accessories that an operator wishes to releasably latch to that vehicle. The specific location of the support member on the vehicle is not particularly limiting. For example, the support member may be provided near a front portion of the vehicle (e.g., handlebars), near a middle portion of the vehicle (e.g., frame, Roll-Over Protective Structure), and near a rear portion of the vehicle (e.g., a rear cabin). It is understood that the support member may be a structural component of other types of vehicles, such as agricultural, industrial, military, and exploratory vehicles for instances.

It is contemplated that the base 200 may be selectively attached to the structure component using a variety of anchoring systems. In one embodiment, the base 200 may be selectively attaching using an anchoring system 500 (shown in FIGS. 7A, 7B, 8A, 8B, 9A to 9C and 10A to 10D) described in U.S. Pat. No. 10,392,069, entitled “Attachment system and method of using the same”, the contents of which is incorporated herein by reference in its entirety. Other known devices for selectively attaching the base 200 to the structural vehicle are also contemplated. The anchoring system 500 may be adjustable between connecting and fixing configuration, with the anchoring system being selectively connected to the vehicle when in the connecting configuration and fixed to the vehicle when in the fixing configuration.

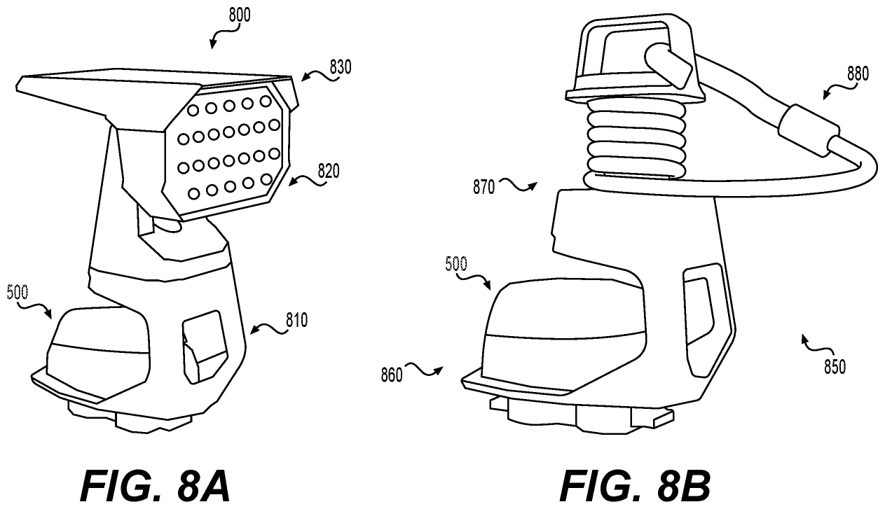

With a quick reference to FIG. 8A there is depicted a mounting system 800 comprising a base 810 and a swivel member 820. In this embodiment, the swivel member 820 includes a light 830. With a quick reference to FIG. 8B there is depicted a mounting system 850 comprising a base 860 and a swivel member 870. In this embodiment, the swivel member 870 includes a catching line 880. It is contemplated that a given swivel member may include an accessory portion for releasably attaching a tool and/or accessory (such as in FIGS. 7A and 7B) and/or may include the tool and/or accessory (such as in FIGS. 8A and 8B).

The swivel member 300 of the mounting system 100 is “interchangeable”. In some embodiments, the resilient connection assembly 400 may allow an operator to interchange the swivel member 300 with the swivel member 820 and/or swivel member 870 and/or other swivel members contemplated in the context of the present technology. In other embodiments, the mounting system 100 may be provided as a kit comprising the base 200, the resilient connection assembly 400 and one or more amongst the swivel member 300, the swivel member 820, the swivel member 870, and other swivel members contemplated herein.

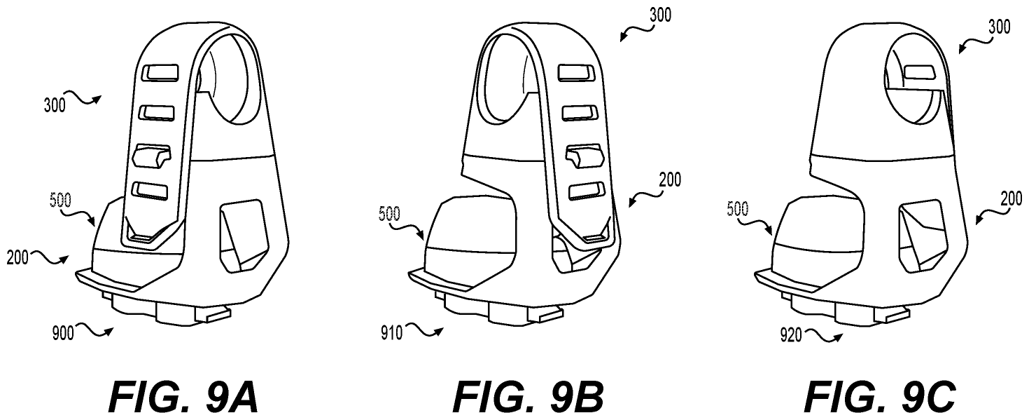

Furthermore, the interface 299 and the resilient connection assembly 400 may allow an operator to selectively engage the base 200 with the swivel member 300 in a plurality of “configurations”. With a quick reference to FIGS. 9A-C, the swivel member 300 is selectively engaged with the base 200 in a first configuration 900, a second configured 910 and a third configuration 920, respectively. How the base 200 and the swivel member 300 can be selectively engaged in a plurality of configurations will be described in greater details herein further below.

### Base

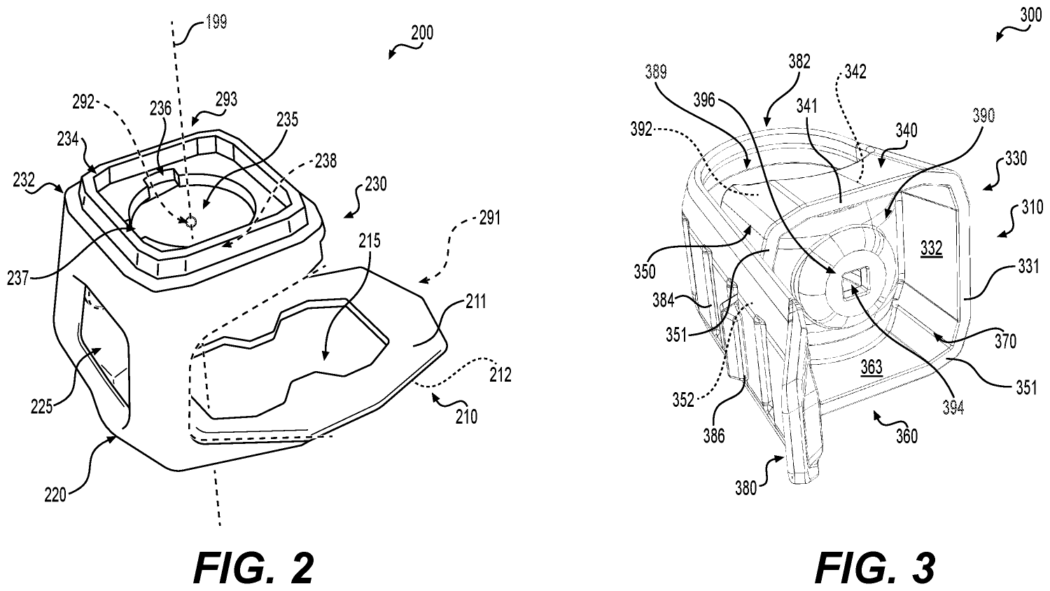

With reference to FIG. 2, there is depicted the base 200 of the mounting system 100 without the swivel member 300 and the resilient connection assembly 400. In this embodiment, the base 200 comprises a foot portion 210, an intermediate portion 220, and a connecting portion 230. The intermediate portion 220 extends away from the foot portion 210 and towards the connecting portion 230.

In this embodiment, the foot portion 210, the intermediate portion 220, and the connecting portion 230 define an open-ended u-shaped space 291. The open-ended u-shaped space 291 by the base 200 may provide better access to an operator during assembly of the mounting system 100 and/or during operation of the mounting system 100.

In this embodiment, the intermediate portion 220 defines an aperture 225. In some implementations of the present technology, the aperture 225 may be used by the operator for receiving a strap (not depicted) to secure one or more accessories to the base 200. It is also contemplated that the intermediate portion 220 may be provided with the aperture 225 for reducing weight of the mounting system 100. In is also contemplated that the aperture 225 may further facilitate access to the open-ended u-shape space 291 of the base 200.

The foot portion 210 has a top surface 211, a bottom surface 212 and defines a foot aperture 215. In this embodiment, the top surface 211 and the bottom surface 212 are generally flat. In other embodiments, the bottom surface 212 may be curved to match a profile of a structural component of the vehicle to which the base 200 is to be attached.

In this embodiment, the foot aperture 215 is configured to cooperate with an anchoring system (not depicted) for selectively attaching the base 200 to a vehicle (not depicted). However, in other embodiments, the foot portion 210 may be adapted in a different manner for selective attachment to the vehicle. In further embodiments, the foot portion 210 may also be selectively attached using fasteners, clamps and/or other selective attachment components.

The connection portion 230 is a portion of the interface 299 of the mounting system 100. It can be said that the connecting portion 230 is a first interface portion of the interface 299. As illustrated, the axis 199 extends though the connecting portion 230. It is contemplated that in other embodiments of the present technology, the axis 199 may not extend through the foot portion 210. For example, instead of being generally perpendicular (e.g., extending vertically) to a top surface of the foot portion 210, the axis 199 may be generally parallel (e.g., extending horizontally) to the foot portion 210, or may be at an angle with a top surface of the foot portion 210.

In this embodiment, the connecting portion 230 defines an aperture 235. As it will be described in greater details below, the aperture 235 is configured to receive at least some components of the resilient connecting assembly 400. A wall of the aperture 235 defines three notches 236, 237, and 238. It is contemplated that the wall of the aperture 235 may define one or more notches, or none at all.

The three notches 236, 237, and 238 may cooperate with corresponding structures of at least one component of the resilient connecting assembly 400 for (i) orienting the resilient connecting assembly 400 relative to the connecting portion 230, (ii) guiding the resilient connecting assembly 400 when the at least some component of the resilient connecting assembly 400 are received in the aperture 235, and (iii) prevent rotational movement of at least one component of the resilient connecting assembly 400 during operation of the mounting system 100.

In this embodiment, the aperture 235 has a circular shape. It is contemplated that the aperture 235 may have a different shape such as, for example, a triangular shape, a square shape, a rectangular shape, a pentagonal shape, a hexagonal shape, and the like. It is contemplated that the shape of the aperture 235 can match a shape of at least one component of the resilient connecting assembly 400 that is received therein. The aperture 235 has a virtual center point 292. The axis 199 extends perpendicularly to the aperture 235 and through the virtual center point 292.

In this embodiment, the connecting portion 230 comprises a shoulder 232 and a lip 234. The shoulder 232 is defined about the perimeter of a top surface 293. The lip 234 protrudes from the top surface 293 of the connecting portion 230 and about the aperture 235. The shoulder 232 and the lip 234 are configured to selectively engage interfacing structures of the swivel member 300.

It is contemplated that the connecting portion 230 may comprise other types of interfacing structures than the shoulder 232 and the lip 234. Interfacing structures of the connecting portion 230 may depend on inter alia a specific configuration of an interface of a mounting system. This means that the interface of the mounting system may be different from a “shoulder-lip” configuration of the non-limiting embodiment of FIG. 2, and without departing from the scope of the present technology. For example, the interface of the mounting system may have a “male-female” configuration in other embodiments of the present technology.

### Swivel Member

With reference to FIG. 3, there is depicted the swivel member 300 of the mounting system 100 without the base 200 and the resilient connection assembly 400. Generally speaking, the swivel member 300 comprises a receiving portion 310 and an accessory portion 320.

In this embodiment, the accessory portion 320 has a belt 380 with belt apertures 382 that are configured to selectively cooperate with a retention element 386 protruding from the swivel member 300 for selectively controlling a size of an opening 389. The operator may use the belt 380 to secure a given accessory/tool in the opening 389. Additionally, the accessory portion 320 provides a handle 382 for the operator to handle the swivel member 300. In other embodiments, such as in the case of the swivel members 820 and 870 (see FIGS. 8A and 8B), an accessory portion of a given swivel member may be a given accessory itself. For example, the swivel member 820 includes the light 830 and the swivel member 870 include the catching line 880.

In this embodiment, the receiving portion 310 is a portion of the interface 299 of the mounting system 100. It can be said that the receiving portion 310 is a second interface portion of the interface 299. The axis 199 extends though the receiving portion 310 when the swivel member 230 is resiliently connected to the base 200.

In this embodiment, the receiving portion 310 comprises a ceiling 390. The ceiling 290 comprises a recessed portion 396 in which an aperture 394 is defined. As it will be described in greater details herein below, the aperture 394 is configured to receive at least one component of the resilient connecting assembly 400 and the recessed portion 396 is configured to nest a portion of the at least one component of the resilient connecting assembly 400 such that the at least one component of the resilient connecting assembly 400 is flush with a top surface 392 of the ceiling 390. In other embodiments, the recessed portion 396 may be omitted. In this embodiment, the ceiling 390 has a curved shape for defining a circular shape of the opening 389. In other embodiments, the ceiling 390 may be generally flat.

In this embodiment, the receiving portion 310 comprises walls 330, 340, 350, and 360 protruding from and extending away from the ceiling 390. It is contemplated that a receiving portion may comprise more or fewer than four walls. An inner space 370 is defined by the ceiling 390 and the walls 330, 340, 350, and 360. The inner space 370 provides room in the receiving portion 310 for selectively receiving the lip 234 and at least some components of the resilient connecting assembly 400.

The walls 330, 340, 350, and 360 have bottom surfaces 331, 341, 351, and 361, respectively, and interior surfaces 332, 342, 352, and 362, respectively. The walls 330, 340, 350, and 360 are configured to selectively engage the shoulder 232 and the lip 234 of the connecting portion 230. How the walls 330, 340, 350, and 360 are configured to selectively engage the shoulder 232 and the lip 234 will be described in greater details herein below.

It can be said that the walls 330, 340, 350, and 360 are interfacing structures of the swivel member 300. In some embodiments, the swivel member 300 may comprise interfacing structures of the base 200, while the base 200 may comprise the interfacing structures of the swivel member 300, without departing from the scope of the present technology.

### Resilient Connection Assembly

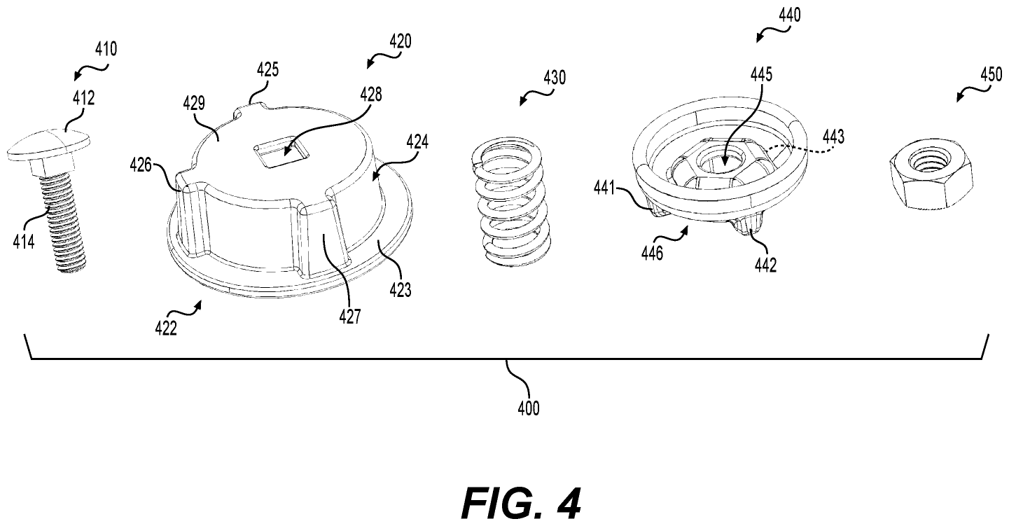

With reference to FIG. 4, there is depicted a plurality of components of the resilient connection assembly 400. The resilient connection assembly 400 comprises a fastener 410, a body 420, a spring 430 (a resilient element), a handle 440 and a nut 450.

The fastener 410 has a head 412 and a threaded shank 414. The nut 450 is configured to cooperate with the threaded shank 414. When the mounting system 100 is assembled, the head 412 is received in the recessed portion 396 (see FIG. 3).

The body 420 has a lip 422, a ceiling 429 and a wall 424. The lip 422 has a surface 423. The wall 424 includes three grooves 425, 426, and 427. The grooves 425, 426, and 427 are configured to cooperate with the notches 236, 237, and 238 (see FIG. 2). The ceiling 429 has an aperture 428. The aperture 428 receives the threaded shank 414. As it will be described below, the body 420 defines an interior space for providing room for at least some components of the resilient connection assembly 400 when the mounting system 100 is assembled.

The spring 430 receives the threaded shank 414. The spring 430 is configured to be received in the interior space of the body 420. A handle 440 has an aperture 445 for receiving the threaded shank 414. Optionally, the human operator may use the handle 440 for manually adjusting the biasing force of the spring 430. For example, the operator may operate the handle 440 to move it along the threaded shank 414, which results in compression and/or decompression of the spring 430. In other embodiments, the biasing force may be pre-determined and non-adjustable.

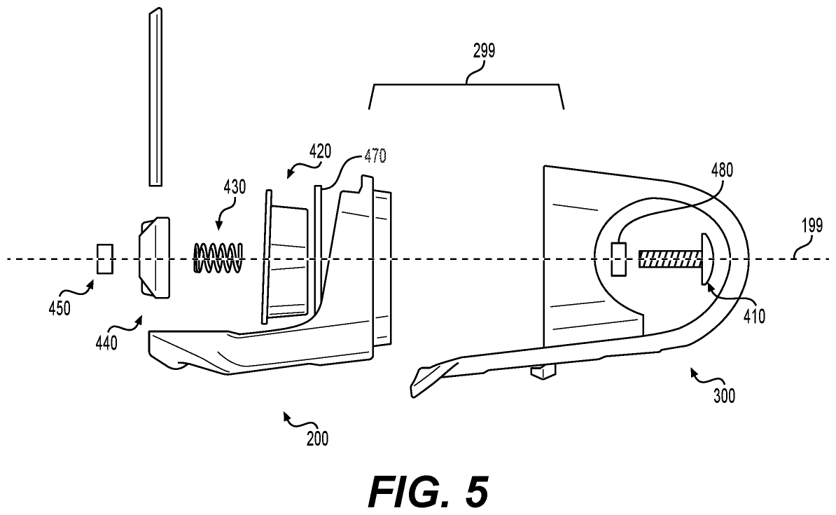

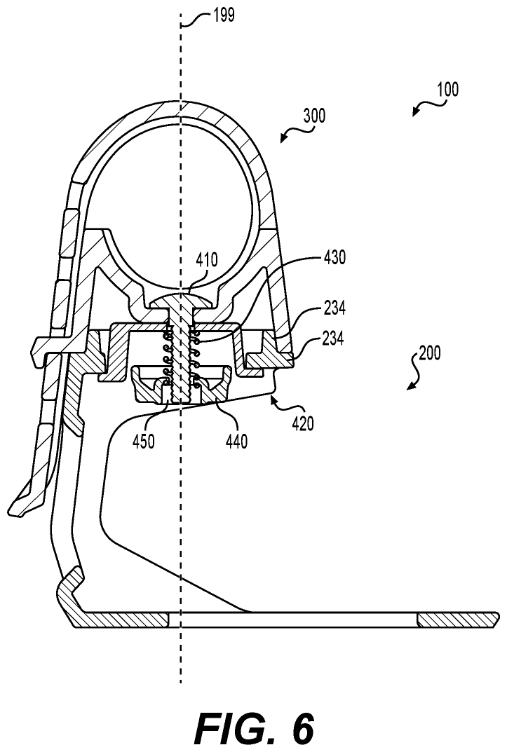

The resilient connection assembly 400 is configured to resiliently connect the swivel member 300 to the base 200. The resilient connection assembly 400 comprises the spring 430 configured to exert a biasing force to axially bias the receiving portion 310 against the connection portion 230. It is understood that the depicted resilient connection assembly 400 is only an example and that other configurations are considered as well. How the operator can assemble the mounting system 100 will now be described with reference to FIGS. 5 and 6.

### Kit Assembly

With reference to FIG. 5, there is depicted an exploded view the mounting system 100.

During assembly the operator inserts the body 420 into the aperture 235 of the connecting portion 230. The grooves 425, 426, 427 are received in the notches 236, 237, 238. The grooves 425, 426, 427 and the notches 236, 237, 238 aid the operator in aligning the body 420 relative to the aperture 235 and prevent rotational movement of the body 420 relative to the aperture 235 about the axis 199. When the body 420 is inserted into the aperture 235, the surface 423 of the lip 422 of the body 420 abuts the connecting portion 230. In some embodiments, a gasket 470 (shown in FIG. 5) may be disposed on the lip 422 (so as to be between the body 420 and the connecting portion 230) for limiting passage of debris such as dust, sand and/or water therebetween.

During assembly, the operator inserts the threaded shank 414 of the fastener 410 through the aperture 395 of the ceiling 394 of the swivel member 300. When the threaded shank 414 is received in the aperture 395, the head 412 rests in the recessed portion 396. In some embodiments, a gasket 480 (shown in FIG. 5) may be disposed in the recessed portion 396, between the head 412 and the ceiling 394.

The operator further inserts the threaded shank 414 of the fastener 410 through the aperture 428 of the ceiling 429 of the body 420. At this time, the receiving portion 310 and the connecting portion 230 are engaged with each other. The shape of the lip 234 and the shoulder 232 and of the walls of the receiving portion 310 may aid in aligning the receiving portion 310 relative to the connecting portion 230. When engaged, the bottom surfaces 331, 341, 351, 361 of the walls 330, 340, 350, 360 rest on the shoulder 232 and the lip 234 is received in the interior space 370 and abut the inner surfaces 232, 242, 252, 262 of the walls 330, 340, 350, 360.

The operator then inserts the threaded shank 414 through the spring 430. The operator then inserts the threaded shank 414 through the aperture 445 of the handle 440. The operator then threads the bolt 450 onto the threaded shank 414.

With reference to FIG. 6, there is depicted a cross-sectional view 600, passing through the line 6-6 of FIG. 1, of the assembled mounting system 100. When assembled, the spring 430 biases the head 412 against the recessed portion 396, the ceiling 429 against the recessed portion 396, the lip 422 against the connecting portion 210 and the bottom surfaces 331, 341, 351, 361 of the walls 330, 340, 350, 360 against the shoulder 232.

### Operation

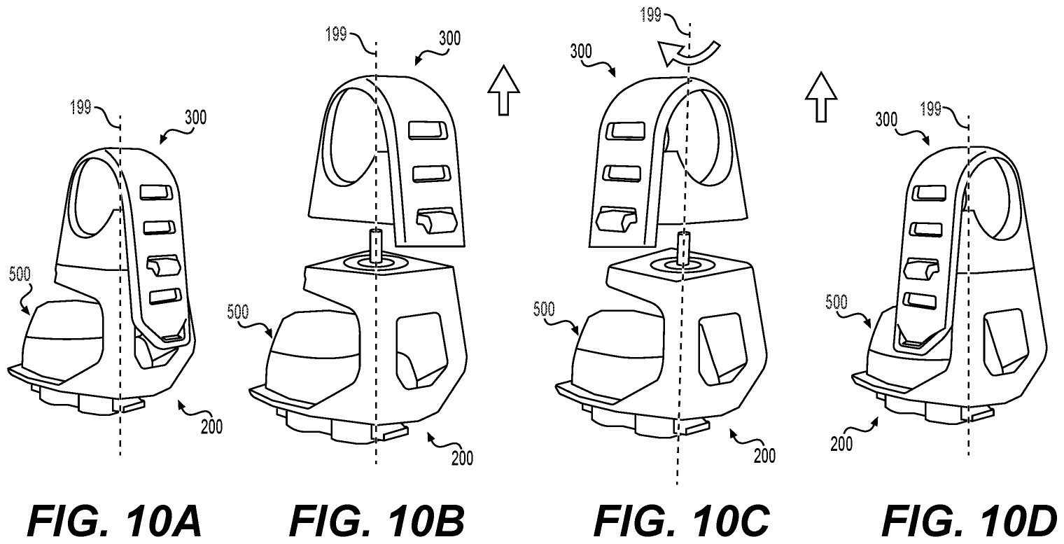

With reference to FIGS. 10A-10D, there is depicted a series of schematic illustrations of how the operator may operate the mounting system 100 for selectively engaging the base 200 with the swivel member 300 in a second configuration when the base 200 and the swivel member 300 are originally in a first configuration. However, it should be noted that the operator may operate the mounting system 100 for selectively engaging the base 200 with the swivel member 300 in a plurality of different configurations.

In FIG. 10 A, the connecting portion 230 and the receiving portion 310 are selectively engaged in a first configuration. In the first configuration, the swivel member 300 is prevented from rotating relative to the base 200 about the axis 199. Indeed, when the lip 234 of the connecting portion 230 is received by the receiving portion, the lip 234 prevents rotation of the walls 330, 340, 350, 360 about the axis 199.

As seen in FIG. 10B, the operator axially pulls the swivel member 300 away from the base 200, and the receiving portion 310 disengages the connecting portion 230. When the receiving portion 310 and the connecting portion 230 are disengaged, the operator (while axially pulling the receiving portion 310 away from the connecting portion 230) rotates/swivels the swivel member 300 relative to the base about the axis 199 such that the swivel member 300 is rotated from a first position thereof about the axis 199 to a second position thereof about the axis 199 depicted in FIG. 10C.

As seen in FIG. 10C, the operator releases the swivel member 300 while the swivel member 300 is in the second position about the axis 199, and spring 430 axially biases the receiving portion 310 towards the connecting portion 230 such that the receiving portion engages the connecting portion 230 in the second configuration as seen in FIG. 10D.

The various components of the mounting system 100 are made of conventional materials (e.g., metallic materials, such as steel or aluminum, non-metallic material, such as plastics, rubber, and/or composite materials) via conventional manufacturing processes (e.g., casting, molding, 3d printing, etc.). The present technology does not require any specific materials nor methods of manufacture. The present technology merely requires that each component be suitable for the purpose for which it is intended and the use to which it is to be put. Any material(s) or method(s) of manufacture which produce such components may be used in the present technology.

### Alternative Embodiment

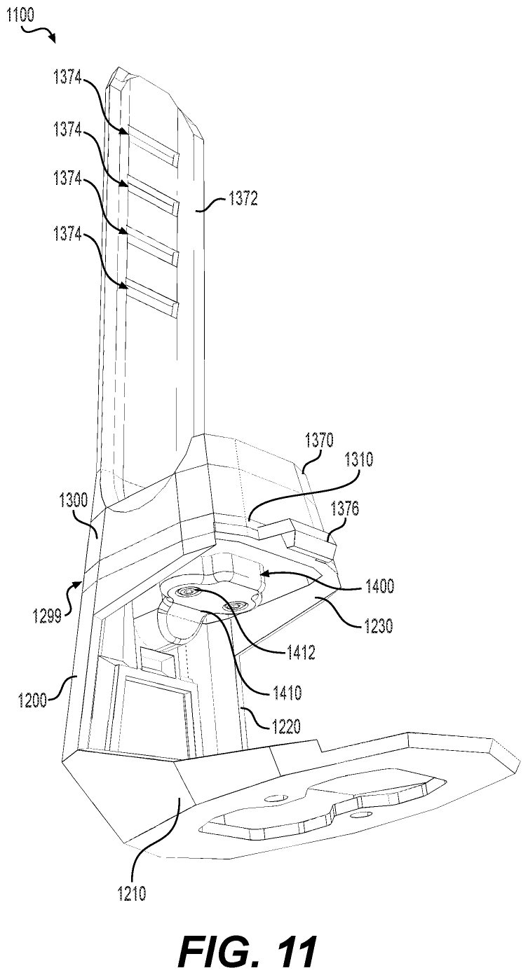

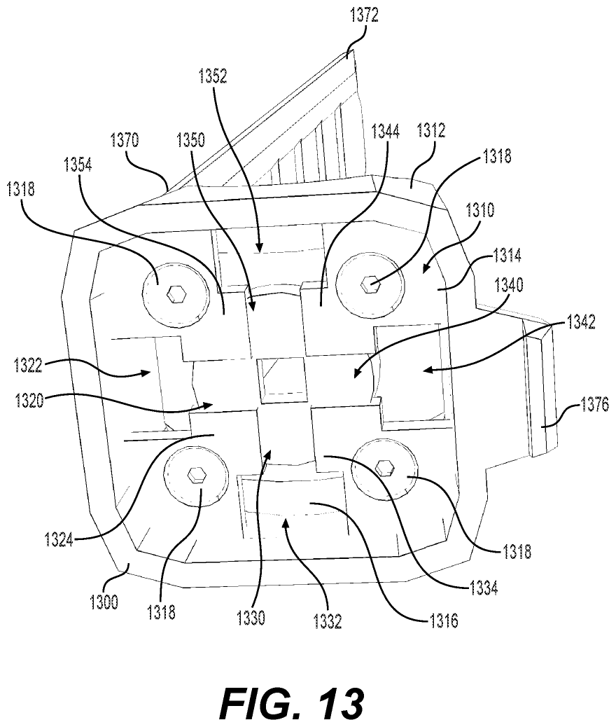

With reference to FIGS. 11 to 17, an alternative embodiment of the mounting system 100, namely mounting system 1100, will now be described in greater detail. The mounting system 1100 includes a base 1200, an interchangeable swivel member 1300 and a stopping assembly 1400. The base 1200 and the interchangeable swivel member 1300 are connected to one another at an interface 1299 of the mounting system 1100 by a base interface portion 1230 and a swivel interface portion 1310. The base and interchangeable swivel interface portions 1230, 1310 are configured such that the base and interchangeable swivel members 1200, 1300 can be connected to one another in four different configurations. It is contemplated that in other embodiments, the base and interchangeable swivel members 1200, 1300 could be connected in two, three, or five or more configurations. Additionally, the interchangeable swivel member 1300 can be interchanged with another swivel member.

### Base

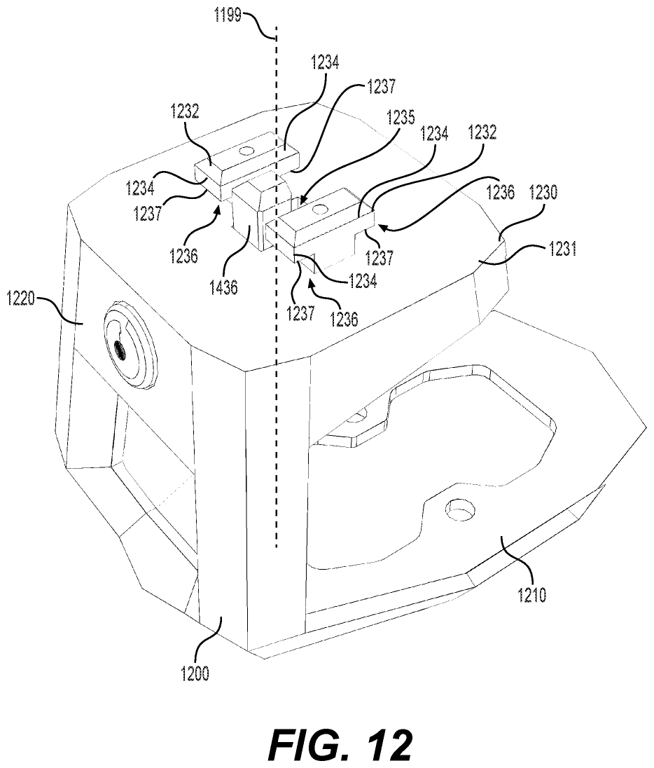

Referring to FIG. 12, the base 1200 will first be described in greater detail. The base 1200 defines an axis 1199 that extends therethrough. In the illustrated embodiment, the axis 1199 extends in the vertical direction, but it is contemplated that in other embodiments, where the mounting system 1100 is oriented differently, the axis 1199 may extend in a different direction (e.g., the axis 1199 could extend horizontally or at a predetermined angle). The base 1200 includes a foot portion 1210, an intermediate portion 1220, and a connecting portion 1230. The intermediate portion 1220 extends away from the foot portion 1210 and towards the connecting portion 1230. The foot and intermediate portions 1210, 1220 are similar to the foot and intermediate portions 210, 220, and hence will not be redescribed herewith.

The connection portion 1230 is a portion of the interface 1299, such that it can be said that the connecting portion 1230 is the base interface portion 1230 of the interface 1299.

The base interface portion 1230 defines, generally at a center thereof, an aperture 1235 that is disposed such that a center of the aperture 1235 is aligned with the axis 1199. It is contemplated that in other embodiments, the aperture 1235 could be disposed such that the center of the aperture 1235 may be offset from the axis 1199. In the illustrated embodiment, the aperture 1235 has a rectangular shape, but it is contemplated that in other embodiments, the aperture 1235 could define another shape. As will be described in greater detail below, the aperture 1235 is configured to receive part of the stopping assembly 1400 therein.

The base interface portion 1230 has two retainers 1232 disposed on either lateral side (where the intermediate portion 1220 corresponds to the front side) of the aperture 1235. It is contemplated that in other embodiments, the base interface portion 1230 could have a single retainer or three or more retainers. As the two retainers 1232 are similar, only one will be described herewith.

The retainer 1232 extends upwardly from an upper surface 1231 of the base 1200. In some embodiments, the retainer 1232 is integral with the base 1200. In other embodiments, the retainer 1232 is a separate component connected to the base 1200 by a fastener. The retainer 1232 has a T-shape, such that the retainer 1232 has two abutting sections 1234 disposed on either longitudinal side thereof. Gaps 1236 are defined between lower surfaces 1237 of each of the abutting sections 1234 and the upper surface 1231 of the base 1200. As will be described below, the gaps 1236 are configured to receive part of the swivel interface portion 1310 therein.

### Interchangeable Swivel Member

With reference to FIGS. 11, 13, 14 and 16, the interchangeable swivel member 1300 (henceforth simply referred to as swivel member 1300) will be described in greater detail. The swivel member 1300 has a connecting portion 1310 and an accessory portion 1370.

The connecting portion 1310 is a portion of the interface 1299, such that it can be said that the connecting portion 1310 is the swivel interface portion 1310.

The swivel interface portion 1310 includes a housing segment 1312 and an engaging segment 1314 that is partially received in the housing segment 1312. More specifically, the housing segment 1312 defines an inner space 1319 with a ceiling 1316, and a shoulder 1317, and the engaging segment 1314 abuts the shoulder 1317, and is spaced from the ceiling 1316. The spacing between an upper surface 1315 of the engaging segment 1314 and the ceiling 1316 is such that the abutting sections 1234 of the retainers 1232 may be received therein. In the present embodiment, the engaging segment 1314 is connected to the housing segment 1312 by fasteners 1318. It is contemplated that in other embodiments, the housing and engaging segments 1314 could be one integral part. It is further contemplated that in some embodiments, the housing segment 1312 could be part of the accessory portion 1370, such that the engaging segment 1314 itself would be the swivel interface portion 1310.

The engaging segment 1314 defines a cross-like recess that is configured to engage with the base interface portion 1230. More specifically, the engaging segment 1314 defines a first passage 1320 connected to a first opening 1322, a second passage 1330 connected to a second opening 1332, a third passage 1340 connected to a third opening 1342, and a fourth passage 1350 connected to a fourth opening 1352. The first passage 1320 and the first opening 1322 generally define a T-shape. The second passage 1330 and the second opening 1332 generally define a T-shape. The third passage 1340 and the third opening 1342 generally define a T-shape. The fourth passage 1350 and the fourth opening 1352 generally define a T-shape. It is understood that in embodiments with a different number of passages, the engaging segment 1314 would define a shape different from a cross-like recess.

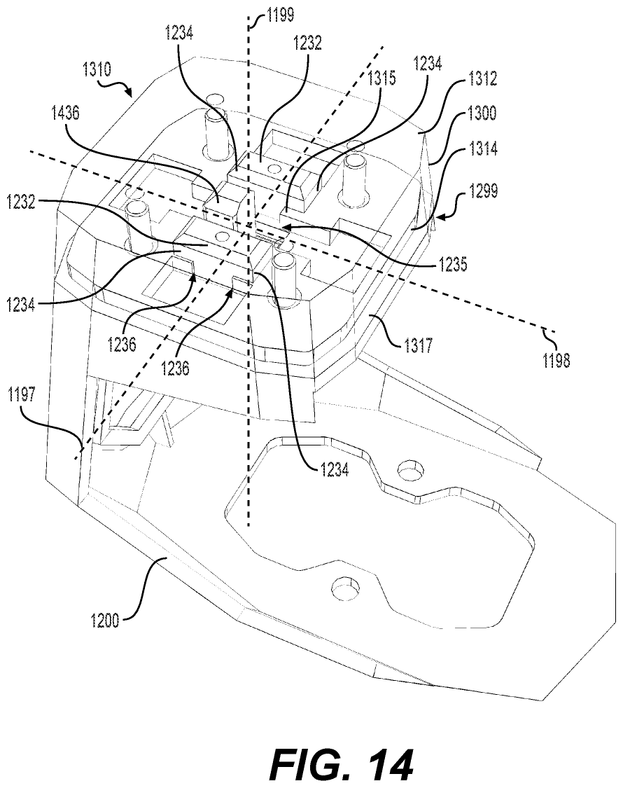

The first, second, third and fourth passages 1320, 1330, 1340, 1350 intersect at a center of the housing segment 1312. When the swivel interface portion 1310 is connected to the base interface portion 1230, a center of the intersection coincides with the axis 1199. The first and third passages 1320, 1340 are aligned along an axis 1198. When the swivel interface portion 1310 is connected to the base interface portion 1230, the axis 1198 is orthogonal to the axis 1199. The second and fourth passages 1330, 1350 are aligned along an axis 1197. When the swivel interface portion 1310 is connected to the base interface portion 1230, the axis 1197 is orthogonal to the axes 1198, 1199. The first, second, third and fourth passages 1320, 1330, 1340, 150 are thus equally angularly spaced (at 90 degrees from one another). As a result of the first, second, third and fourth passages 1320, 1330, 1340, 1350, the housing segment 1312 has a first abutting portion 1324, a second abutting portion 1334, a third abutting portion 1344, and a fourth abutting portion 1354. As best seen in FIG. 14, the first, second, third and fourth abutting portions 1324, 1334, 1344, 1354 are sized so that they may each fit into the gaps 1236. It is contemplated that in other embodiments, there could only be two passages and two openings. It is also contemplated that there could only be three passages and three openings. It is further contemplated that there could be five or more passages and a corresponding number of openings. In such embodiments, the axes 1197, 1198, 1199 may not be orthogonal to one another. As will be described in greater detail below, the number of passages and openings correspond to the number of different configurations in which the swivel member 1300 and the base 1200 can be connected to one another.

It will be noted that the swivel interface portion 1310 and the base interface portion 1230 may be configured to receive a gasket therein, for limiting the amount of debris and/or dust that may infiltrate therebetween.

Referring to FIG. 11, the accessory portion 1370 extends above the swivel interface portion 1310. In the illustrated embodiment, the accessory portion 1370 and the swivel interface portion 1310 are integral. More specifically, the accessory portion 1370 is integral with the housing segment 1312. It is contemplated that in other embodiments, the accessory portion 1370 could be selectively connected to swivel interface portion 1310, so that, if desired, another accessory portion may be connected to the swivel interface portion 1310. The accessory portion 1370 has a belt 1372 with belt apertures 1374 that are configured to selectively cooperate with a retention element 1376 protruding from the swivel member 1300 for selectively controlling a size of an opening formed by the belt 1372. The operator may use the belt 1372 to secure a given accessory/tool in the opening. In other embodiments, the accessory portion 1370 may be a given accessory itself. For example, the accessory portion 1370 may include a light or a catching line.

### Stopping Assembly

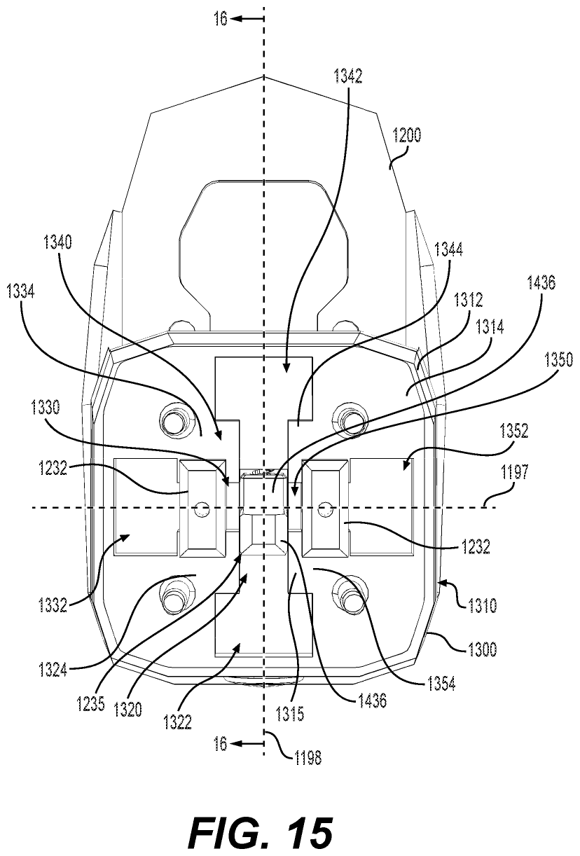

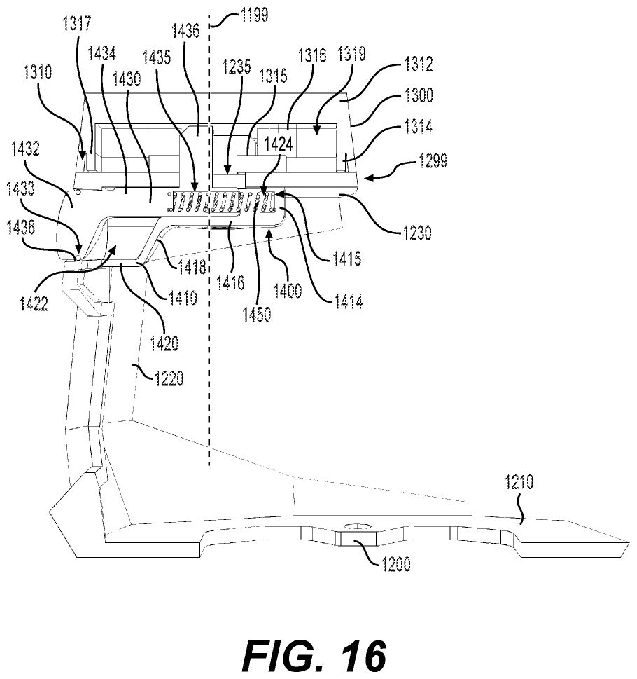

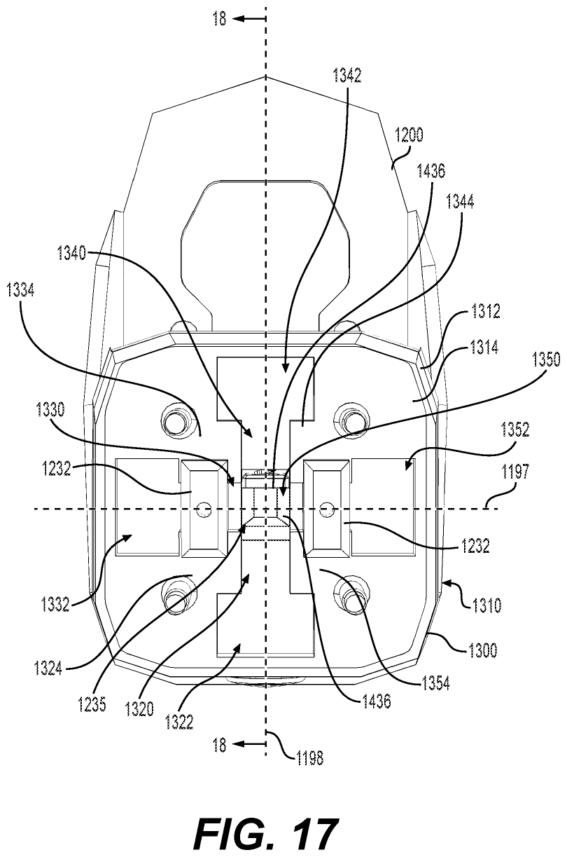

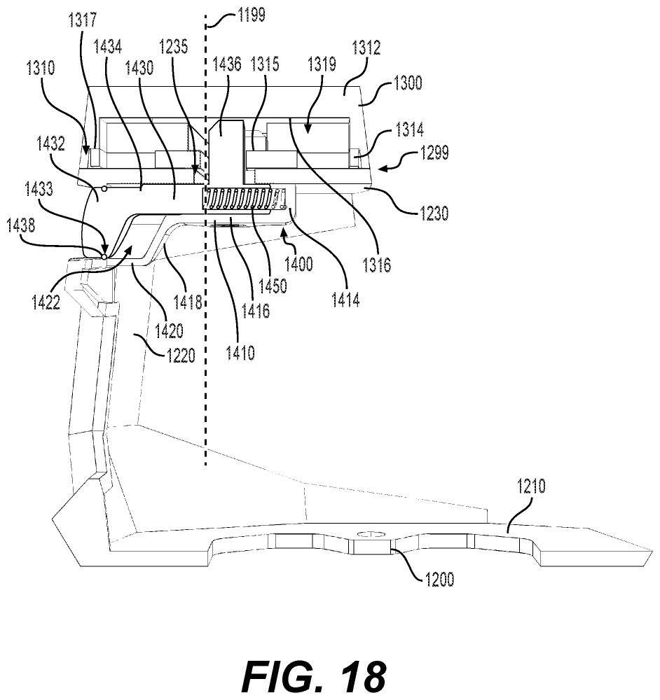

With reference to FIGS. 11, and 15 to 18, the stopping assembly 1400, which is connected to the base 1200, will be described in greater detail. The stopping assembly 1400 includes a cover member 1410, a stopping member 1430, and a biasing member 1450. As will be described below, the stopping member 1430 is moveable between a stopping position (FIGS. 15 and 16) and a releasing position (FIGS. 17 and 18), and is biased toward the stopping position by the biasing member 1450.

The cover member 1410 is connected to an underside of the connecting portion 1230 by fasteners 1412. In the illustrated embodiment, there are two fasteners 1412, each of which extends into a respective retainer 1232, though it is understood that this may not be the case in other embodiments. The cover member 1410 has an end segment 1414, a supporting segment 1416, an angled segment 1418 and a front segment 1420.

The end segment 1414 extends generally orthogonally from the underside of the connecting portion 1230, and defines a recess 1415 therein. As will be described below, the recess 1415 is configured to receive part of the biasing member 1450 therein. In some embodiments, the recess 1415 could be omitted. In other embodiments, the recess 1415 could be replaced by a protrusion.

The supporting segment 1416 extends generally orthogonally from the end segment 1414, toward the intermediate portion 1220 of the base 1200. As will be described below, the supporting segment 1416 is configured to support part of the stopping member 1430.

The angled segment 1418 extends at an angle from the supporting segment 1416. More specifically, the angled segment 1418 extends, with reference to FIGS. 16 and 18, vertically downward and longitudinally toward the intermediate portion 1220.

The front segment 1420 extends generally parallel to the supporting segment 1416, though it is contemplated that the front segment 1420 may extend differently in other embodiments. The front segment 1420 abuts the intermediate portion 1220.

Due to a shape of the cover member 1410, the cover member 1410 and the underside of the connecting portion 1230 define therebetween an enlarged region 1422 and a narrowed region 1424.

The stopping member 1430, which is supported by the cover member 1410, is, in part, disposed between the cover member 1410 and the connecting portion 1230. The stopping member 1430 includes an engaging portion 1432, an intermediate portion 1434 and a stopping portion 1436.

The engaging portion 1432 has a partially cylindrical shape, and is engageable by a user. For ease of use, the engaging portion 1432 partly extends beyond a front surface of the intermediate portion 1220. The engaging portion 1432 may simply be referred to as a button. The engaging portion 1432 defines a recess 1433 on a circumference thereof, in which a gasket 1438 is received. The gasket 1438 can reduce infiltration of debris such as dust, sand and/or water within the enlarged and narrowed regions 1422, 1424. The engaging portion 1432 is received in the enlarged region 1422, which is sized to accommodate the engaging portion 1432 as the stopping member 1430 moves between the stopping and releasing positions.

The intermediate portion 1434 extends from the engaging portion 1432 toward the end segment 1414 of the cover member 1410. Part of the intermediate portion 1434 is supported by the supporting segment 1416 of the cover member 1410. It is to be noted that as the stopping member 1430 moves between the stopping and releasing positions, the intermediate portion 1434 slides on the supporting segment 1416 of the cover member 1410. In some embodiments, the intermediate portion 1434 and the supporting segment 1416 are made of material having low friction therebetween. In other embodiments, friction therebetween may be modulated by changing surface texture. The intermediate portion 1434 defines a recess 1435 for receiving part of the biasing member 1450 therein. In some embodiments, the recess 1435 may be omitted.

The stopping portion 1436 extends generally orthogonally from the intermediate portion 1220. The stopping member 1430 is configured such that when the stopping assembly 1400 is assembled and connected to the base 1200, the stopping portion 1436 extends through the aperture 1235. When the stopping member 1430 is in the stopping position, the stopping portion 1436 abuts a front edge of the aperture 1235. When the stopping member 1430 is in the releasing position, the stopping portion 1436 is generally centered in the aperture 1235. It is contemplated that in other embodiments, the position of the stopping portion 1436 may vary.

The biasing member 1450 is a spring. In other embodiments, the biasing member 1540 could be another member having resilient properties, such as a polymeric member. The biasing member 1450 is partly received in the recess 1415 of the cover member 1410 and the recess 1435 of the stopping member 1430. Being received in the recesses 1415, 1435 can assist in reducing chances of the biasing member 1450 from buckling. The biasing member 1450 is configured to bias the stopping member 1430 toward the stopping position.

### Operation

With reference to FIGS. 15 and 16, when the base interface portion 1230 is connected to the swivel interface portion 1310, and the stopping member 1430 is in the stopping position: the stopping portion 1436 is partly received in the passage 1320, one retainer 1232 is disposed in the passage 1330 and the other retainer 1232 is disposed in the passage 1350. More specifically, the abutting portions 1324, 1334 of the engaging segment 1314 are received in the gaps 1236 of the one retainer 1232, and the abutting portions 1344, 1354 are received in the gaps 1236 of the other retainer 1232. Thus, when the base interface portion 1230 is connected to the swivel interface portion 1310, and the stopping member 1430 is in the stopping position, the swivel member 1300 is prevented from moving relative to the base 1200 along any one of the axes 1197, 1198, 1199.

More specifically, the base 1200 and the swivel member 1300 are prevented from moving away from one another along the axis 1199, because of the engagement between the retainers 1232 and the abutting portions 1324, 1334, 1344, 1354. The swivel member 1300 is also prevented from moving relative to the base 1200 along the axis 1198 because of the engagement between the retainers 1232 and the abutting portions 1324, 1334, 1344, 1354. Additionally, the swivel member 1300 is prevented from moving relative to the base 1200 along the axis 1197 because of the engagement between the stopping portion 1436 of the stopping member 1430 and the abutting portions 1324, 1354.

In some instances, an operator may want to disconnect the swivel member 1300 from the base 1200. This can be done notably to replace the swivel member 1300 with another interchangeable member that may have a different accessory portion connected thereto and/or to change the configuration of the mounting system 1100.

To disconnect the swivel member 1300 from the base 1200, the stopping member 1430 is moved to the releasing position. This can be done by pressing on the engaging portion 1432. In some embodiments, the operator will know that the stopping member 1430 has reached the releasing position, because it will not be possible to further push on the engaging portion 1432. In some embodiments, this may be due to the biasing member 1450 reaching a fully compressed state. In other embodiments, it may be due to the intermediate portion 1434 abutting the end segment 1414. In other embodiments, it may be due to the engaging portion 1432 abutting the angled segment 1418.

When the stopping member 1430 is in the releasing position, the stopping portion 1436 is generally aligned with the passages 1330, 1350 (i.e., aligned with the axis 1197). Thus, being that the stopping portion 1436 no longer engages the abutting portions 1324, 1354, the swivel member 1300 is free to move relative to the base 1200 along the axis 1197. Then, while maintaining the stopping member 1430 in its releasing position, the swivel member 1430 is moved in either direction along the axis 1197. Eventually, the stopping member 1430 can be released once the stopping portion 1436 is fully received in one of the passages 1330, 1350, as it would no longer stop movement of the swivel member 1300 relative to the base 1200 along the axis 1197. Eventually, one retainer 1232 is aligned with one of the openings 1332, 1352, and the other retainer 1232 is aligned with the passages 1320, 1340. Then, the swivel member 1430 is free to be moved along the axis 1199, since the retainers 1232 no longer engage any of the abutting portions 1324, 1334, 1344, 1354, resulting in the swivel member 1430 being disconnected from the base 1200.

Then if the configuration is to be changed, the swivel member 1300 may be rotated about the axis 1199 by 90 degrees, 180 degrees or 270 degrees (because there are four different configurations in the illustrated embodiment). Then, if the swivel member 1300 is to be reconnected to the base 1200, the stopping member 1430 is moved to the releasing position, the retainers 1232 are aligned with one of the openings 1322, 1332, 1342, 1352, and corresponding passages 1320, 1330, 1340, 1350. Then, the swivel member 1300 is moved toward the base 1200 along the axis 1199 until abutment therebetween, and then, the swivel member 1300 is moved along a corresponding one of the axes 1197, 1198 until the abutting portion 1436 reaches the intersection, and returns to the stopping position.

The mounting system 1100 can be advantageous in that for disconnecting the swivel member 1300 from the base 1200, the stopping member 1430 has to be actively actuated, thereby reducing the likelihood of the swivel member 1300 from accidentally disconnecting from the base 1200.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A mounting system for mounting an accessory on a vehicle, comprising:
a base including a foot portion and a first interface portion, the foot portion configured to be selectively connected to the vehicle, the first interface portion extending from the foot portion,
the base defining an axis extending through the first interface portion;
an interchangeable swivel member including a second interface portion and an accessory portion,
the first interface portion and the second interface portion being configured to selectively engage each other in a first configuration and a second configuration,
when the first interface portion and the second interface portion are disengaged, the interchangeable swivel member is rotatable relative to the base about the axis from a first position to a second position;
when the first interface portion and the second interface portion are engaged, the interchangeable swivel member is prevented from rotating relative to the base about the axis,
a resilient connection assembly configured to resiliently connect the interchangeable swivel member to the base, the resilient connection assembly including a biasing element configured to exert a biasing force to axially bias the first interface portion towards the second interface portion such that:
when the interchangeable swivel member is axially pulled by an operator away from the base, the first interface portion disengages the second interface portion,
when the interchangeable swivel member is in the first position and is released by the operator, the first interface portion engages the second interface portion in the first configuration, and
when the interchangeable swivel member is in the second position and is released by the operator, the first interface portion engages the second interface portion in the second configuration.

2. The mounting system of claim 1, wherein one of the first and second interface portions defines a lip and a shoulder, and wherein when the first interface portion engages the second interface portion:
the other one of the first and second interface portions is biased against the shoulder and receives the lip, thereby preventing rotation of the first interface portion relative to the second interface portion about the axis.

3. The mounting system of claim 2, wherein the lip and the shoulder are defined along a perimeter of the one of the first and second interface portions.

4. The mounting system of claim 1, wherein the first interface portion defines a first aperture, the first aperture configured for receiving at least a portion of the resilient connection assembly, the axis extending through the first aperture.

5. The mounting system of claim 1, wherein the resilient connection assembly further includes a biasing adjustment means for manually adjusting the biasing force of the biasing element.

6. The mounting system of claim 1, wherein the resilient connection assembly further includes a fastener configured to apply the biasing force to the interchangeable swivel member.

7. The mounting system of claim 1, wherein the foot portion defines a foot aperture configured to cooperate with an anchoring system for selectively attaching the base to the vehicle.

8. The mounting system of claim 1, wherein the base further includes an intermediate portion extending away from the foot portion and towards the first interface portion.

9. The mounting system of claim 1, wherein the accessory portion is configured to selectively connect the accessory to the interchangeable swivel member.

10. The mounting system of claim 1, wherein the accessory is at least one of a shovel, an axe, a frame member, a retention member, and a light.

11. A kit for mounting an accessory on a vehicle, comprising:
a base including a foot portion and a first interface portion, the foot portion selectable connected to the vehicle, the first interface portion extending from the foot portion,
the base defining an axis extending through the first interface portion;
an interchangeable swivel member including a second interface portion and an accessory portion,
the first interface portion and the second interface portion being configured to selectively engage each other in a first configuration and a second configuration,
when the first interface portion and the second interface portion are disengaged, the interchangeable swivel member is rotatable relative to the base about the axis from a first position to a second position;
when the first interface portion and the second interface portion are engaged, the interchangeable swivel member is prevented from rotating relative to the base about the axis,
a resilient connection assembly configured to resiliently connect the interchangeable swivel member to the base, the resilient connection assembly including a biasing element configured to exert a biasing force to axially bias the first interface portion towards the second interface portion such that:
when the interchangeable swivel member is axially pulled by an operator away from the base, the first interface portion disengages the second interface portion,
when the interchangeable swivel member is in the first position and is released by the operator, the first interface portion engages the second interface portion in the first configuration, and
when the interchangeable swivel member is in the second position and is released by the operator, the first interface portion engages the second interface portion in the second configuration.

12. The kit of claim 11, wherein the kit further comprises an other interchangeable swivel member including an other second interface portion and an other accessory portion, the other accessory portion being different from the accessory portion.

13. The kit of claim 11, wherein the accessory portion is the accessory.

14. A mounting system for mounting an accessory on a vehicle, the mounting system comprising:
a base including:
a foot portion configured to be selectively connectable to the vehicle;
a first interface portion extending from the foot portion, and having a retainer; and
a stopping assembly comprising:
a stopping member moveable between a stopping position and a releasing position; and
a biasing member operatively connected to the stopping member for biasing the stopping member toward the stopping position,
an interchangeable swivel member including:
a second interface portion selectively connectable to the first interface portion in at least two configurations, and
an accessory portion;
with the first interface portion being connected to the second interface portion, and
in response to the stopping member being in the stopping position:
the stopping member stops the interchangeable swivel member from moving relative to the base in a first direction; and
the retainer stops the interchangeable swivel member from moving relative to the base in a second direction and a third direction, the second direction being different from the first direction, and the third direction being different from the first and second directions;
in response to the stopping member being in the releasing position:
the interchangeable swivel member is free to move relative to the base in the first direction, and
in response to the interchangeable swivel member being moved relative to the base in the first direction, the interchangeable swivel member being free to move relative to the base in at least the third direction.

15. The mounting system of claim 14, wherein:
the base defines a base axis extending through the first interface portion;
the first direction extends along a first axis orthogonal to the base axis;
the second direction extends along a second axis orthogonal to the base and first axes; and
the third direction extends along a third axis parallel to the base axis.

16. The mounting system of claim 14, wherein:
the stopping member has a stopping portion configured to abut part of the second interface portion when the stopping member is in the stopping position, and
the second interface portion defines a passage for receiving the stopping portion when the stopping member is in the releasing position.

17. The mounting system of claim 16, wherein the second interface portion defines an opening connected to the passage, the opening being sized to receive the retainer therethrough.

18. The mounting system of claim 14, wherein the retainer defines a gap between an upper surface of the base and a lower surface of the retainer, the gap being configured to receive part of the second interface portion therein.

19. The mounting system of claim 14, wherein the accessory portion includes at least one of: a belt, a shovel, an axe, a frame member, a retention member, and a light.

20. The mounting system of claim 14, wherein the biasing member is a spring.
